(19) United States
(12) Patent Application Publication
(10) Pub. No.: US 2007/0170759 A1
(43) Pub. Date: Jul. 26, 2007

(54) Car Seat

(75) Inventors: Patrick Nolan, Royersford, PA (US); Shiva M. Gangadharan, West Chester, PA (US); Andrew P. Skrzypek, Chadds Ford, PA (US); Daniel J. Brunick, Birdsboro, PA (US)

Correspondence Address: LEMPIA FORMAN LLC, 223 W. JACKSON BLVD., SUITE 620, CHICAGO, IL, 60606, US

(73) Assignee: Graco Children's Products Inc., Exton, PA (US)

(21) Appl. No.: 11/618,170

(22) Filed: Dec. 29, 2006

Related U.S. Application Data
(60) Provisional application No. 60/754,964, filed on Dec. 29, 2005.

(51) Int. Cl. B60N 2/28

(52) U.S. Cl. 297/250.1; 297/440.11; 297/452.56

(57) ABSTRACT

A child booster seat is configured for use in an automobile and includes a seat portion and can also include a backrest connected to the seat. The seat includes a suspended flexible seating surface, and a crash pad mounted onto the seat below the seating surface. During normal use, the seating surface provides enhanced comfort to the occupant. In the event of a sudden deceleration (for instance during an automobile accident), the occupant travels forward and down into the pad, which limits the amount of travel of the occupant and prevents the automobile safety belt from pressing against soft tissue and causing seat belt syndrome while, at the same time, absorbing at least a portion of the shock imparted onto the occupant.

### CROSS-REFERENCE TO RELATED APPLICATIONS

This application claims the benefit of U.S. Provisional Patent Application Ser. No. 60/754,964, filed Dec. 29, 2005, the disclosure of which is hereby incorporated by reference as if set forth in its entirety herein.

### BACKGROUND OF THE INVENTION

1. Field of the Disclosure

The present disclosure is generally directed to car seats, and more particularly to a child's car seat having a suspended fabric seat bottom.

2. Description of Related Art

Conventional car seats for children typically have a seating area with a plastic support surface covered by a padded, fabric overlay. There are a number of different known car seat categories. Each seat category is intended to provide a seat configured to accommodate children of different age and/or weight ranges. Some seat categories employ a seat configuration with a generally upright seat back and a seat bottom. One example of such a car seat category is booster seats.

Booster seats are a type of car seat known for use with children generally in the range of about age 4 to about age 8. Booster seats typically do not incorporate their own safety harness or belt, but instead use a vehicle's three point safety belt to both hold the seat in place and to restrain a child in the seat. For the latter function, a booster seat repositions a vehicle's adult-designed belt to accommodate the size of a child.

Studies conducted by Partners for Child Passenger Safety (PCPS) showed that children in the age range of 4 to 8 year olds are 38% safer in a crash when restrained only by a vehicle's seat belt than when sitting unrestrained in the vehicle's seat. The study also showed that children in the same age range are 59% safer in a crash when seated in a belt-positioning booster seat (BPB) than when restrained only by the vehicle's seat belt. These study results were supported by the American Academy of Pediatrics (AAP).

According to one study, a booster seat properly positions the vehicle's safety belt on the child. This significantly reduces seat belt syndrome injuries. Seat belt syndrome is characterized as intra-abdominal, spinal, and lower extremity injuries to the child that are associated with improper seat belt positioning. Proper seat belt positioning is achieved when the lap belt lies low on the hips of a child and the shoulder belt rests across the sternum and middle of the child's shoulder. Without using a BPB, it is a common occurrence that the lap belt lies on and presses against the soft tissue of the child's abdomen and the shoulder belt lies across their neck or head. This improper shoulder belt positioning will result in the child often putting the shoulder belt behind their head, rendering it useless in a crash.

There are challenges that arise in getting a child in this age range to use a BPB. These challenges typically result from two primary factors: discomfort of the child and the “big kid” factor, i.e., the child believing they are too old or too big to sit in a child seat. Currently, there are known to be more than 40 different BPB models available on the market. With regard to seat comfort, despite numerous attempts to differentiate these many products and to achieve comfort for the child while offering various options, styles, and patterns, these products typically share one common characteristic: the underlying child's seating surface is made of hard plastic. The hard plastic surface causes pressure points against the child's body. These pressure points can lead to discomfort during long trips. Also, the plastic material does not provide sufficient ventilation to the child's legs, buttocks, and back during warm weather. Lack of ventilation is also known to lead to significant discomfort for the child.

With regard to the “big kid” factor, booster seat legislation has driven many states to require that children be seated in a BPB until they are at least 8 years old and/or until they reach a certain weight and/or height threshold. However, progression of a child from a toddler seat to a booster seat is often met with substantial resistance because the child believes they are a “big kid” and no longer wants to be seated in a safety seat. Peer pressure among children in this age range can be significant enough such that a child does not want to be seen by their friends sitting in a “baby seat.” Children typically see all car seats, regardless of the category in which a seat can be classified, as the same. Parents of such children are often tempted to succumb to their child's wishes and prematurely stop using the booster seat. To deter these types of behavior, attempts are being made in the market to appeal to children by way of offering “big kid” features like cup holders and popular fashion themes and designs in the soft goods.

### SUMMARY

In accordance with one aspect of the present invention, a child car seat includes a seat portion having at least one automobile safety harness guide. The seat portion includes a seat base, a carrier supported by the seat base, and a suspended flexible seating surface connected at its perimeter to the carrier.

It should be appreciated that the foregoing and other aspects of the invention will appear from the following description. In the description, reference is made to the accompanying drawings which form a part thereof, and in which there is shown by way of illustration, and not limitation, preferred embodiments of the invention. Such embodiments do not necessarily represent the full scope of the invention, and reference must therefore be made to the claims herein for interpreting the full scope of the invention.

### BRIEF DESCRIPTION OF THE DRAWINGS

Objects, features, and advantages of the present invention will become apparent upon reading the following description in conjunction with the drawing figures, in which:

FIG. 1 is a perspective view of a booster seat constructed in accordance with a preferred embodiment of the present invention;

FIG. 2 is an exploded perspective view of the booster seat illustrated in FIG. 1;

FIG. 3 is an exploded perspective view of the booster seat illustrated in FIG. 1 showing a child seated therein;

FIG. 4 is a front-left perspective view of a seat portion of the booster seat illustrated in FIG. 1 with portions removed to illustrate the seat base including an crash pad constructed in accordance with certain aspects of the present invention;

FIG. 5 is a top plan view of a seat portion of the booster seat similar to FIG. 4 but with the crash pad removed;

FIG. 6 is a side elevation view of the seat portion of the booster seat illustrated in FIG. 1;

FIG. 7 is a rear elevation view of the seat portion of the booster seat illustrated in FIG. 1;

FIG. 8 is a schematic sectional side elevation view of the seat portion of the booster seat illustrated in FIG. 1;

FIG. 9 is a perspective view of a membrane housed in a carrier member that forms the seating surface of the booster seat illustrated in FIG. 1 constructed in accordance with certain aspects of the present invention;

FIG. 9A is a perspective view of a seating surface membrane constructed in accordance with an alternative embodiment;

FIG. 9B is a perspective view of a seating surface membrane constructed in accordance with another alternative embodiment;

FIG. 10 is an enlarged top plan view of the membrane illustrated in FIG. 9;

FIG. 11 is a sectional side elevation view of the membrane illustrated in FIG. 10;

FIG. 12 is another sectional side elevation view of the membrane illustrated in FIG. 10;

FIG. 13 is a perspective view of the booster seat illustrated in FIG. 1 with an attached seat cover;

FIG. 14 is a sectional side elevation view of the booster seat illustrated in FIG. 3 during normal operation;

FIG. 15 is a sectional side elevation view of the booster seat illustrated in FIG. 14 during an occurrence of abrupt deceleration;

FIG. 16 is a perspective view of a multiple zoned seating surface constructed in accordance with an alternative embodiment;

FIG. 17 is a sectional side elevation view of a seat portion of the booster seat including a tension adjustment mechanism constructed in accordance with certain aspects of the present invention.

### DETAILED DESCRIPTION OF THE DISCLOSURE

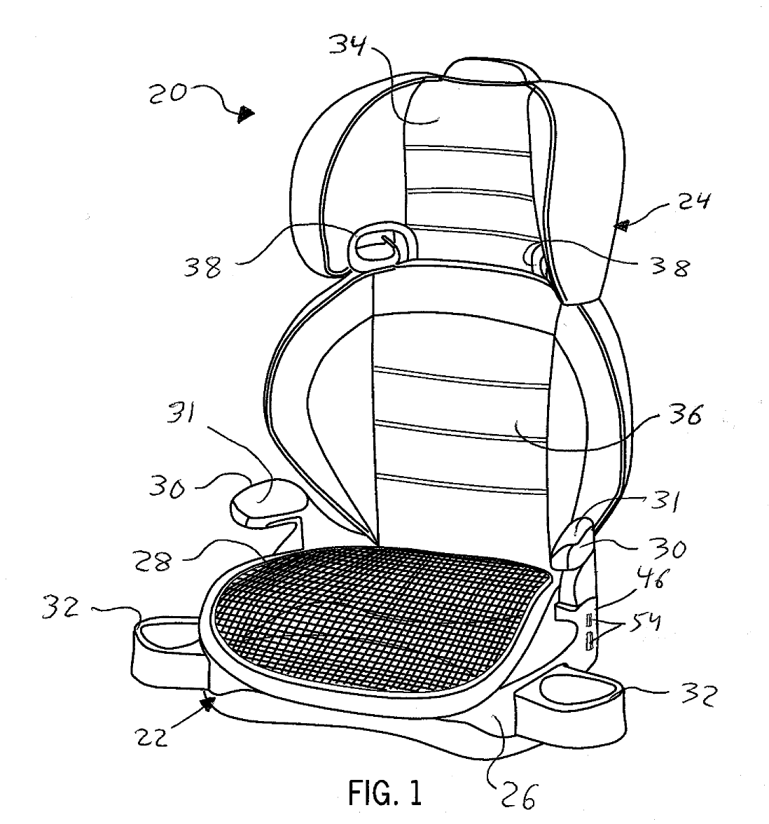

The disclosed car seats are designed and engineered to eliminate or improve upon the problems discussed above with conventional car seats. By way of example, a booster seat 20 is shown and described herein. For instance, referring to FIGS. 1-3, the booster seat components generally include a seat portion 22 and a backrest 24 that is connected to the seat portion 22. The seat 20 defines a rearward end proximate to the backrest 24 and a forward end opposite the rearward end. The seat portion 22 includes a seat base 26 that supports a seating surface 28, a pair of armrests 30, and one or more object holders 32. Each of the various components of the booster seat 20 will now be described.

The backrest 24 includes an upper portion 34 that provides a head rest for an occupant seated in the booster seat 20, and a lower portion 36 that provides a back support for the occupant. A safety belt guide 38 is formed from an opening in the backrest 22 at the lower end of the head rest 34 that is located approximately at shoulder-height of the occupant. Two such belt guides 38 can be provided such that a belt guide is located in juxtaposition with the left and right shoulder of the occupant. The belt guide 38 is positioned to accept a conventional automobile shoulder harness 39 in the usual manner. Accordingly, the occupant can be secured by the automobile safety harness 39 whether the harness is secured over the occupant's left or right shoulder, thus permitting the booster seat 20 to be safely positioned at different locations in the automobile. The armrests 30 also provide a guide for the safety harness insofar as the armrests (typically the lower portion of a given armrest) contacts the automobile safety harness, for instance the automobile lap belt 41 or the lower end of the shoulder harness 39, so as to assist in guiding, locating, or positioning the safety harness.

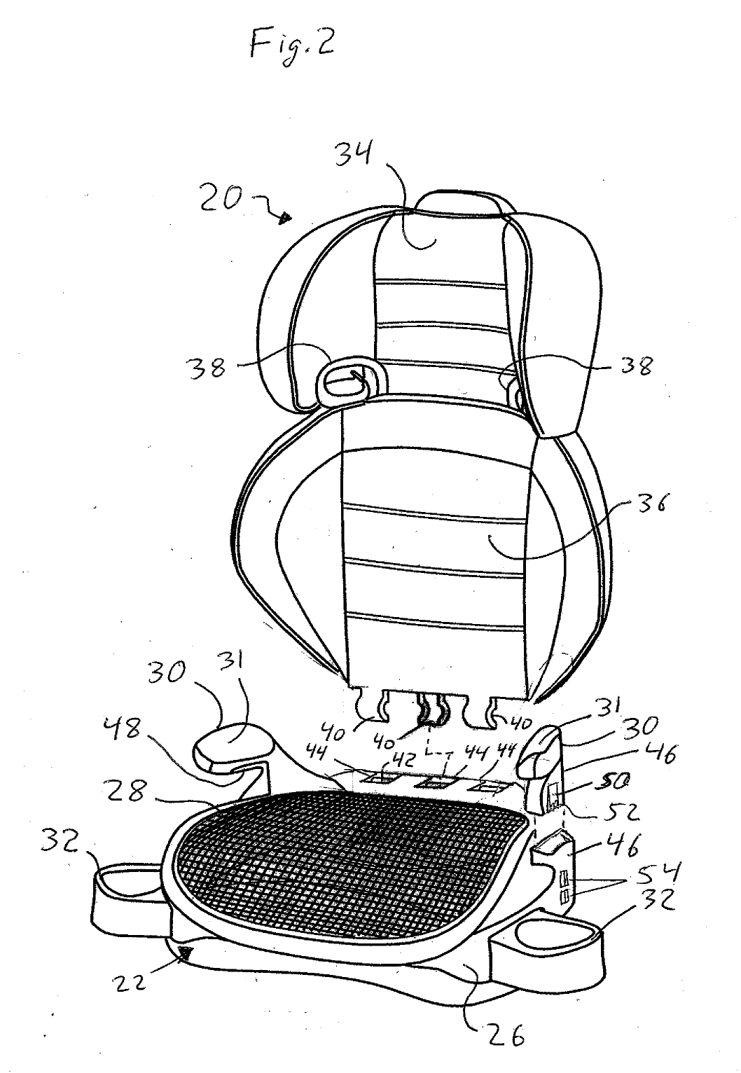

While the booster seat 20 can include the backrest 24 as illustrated, it should be appreciated that the seat portion 22 could be provided without the backrest and that the backrest 24 can be removably and pivotally connected to the seat portion 22. As illustrated in FIG. 2, the backrest 24 can include a plurality of hooks 40 extending downwardly from the bottom portion 36 of the backrest 24. The hooks 40 engage a bar 42 extending laterally proximate to the back edge of the seat base 26. The bar 42 is accessible to the hooks 40 via a plurality of openings 44 formed in the seat base. As shown in FIG. 2, the hooks 40 are arranged so that at least two hooks face in one direction and at least one hook faces in the other direction. The bar 42 can include semi-circular sections (not shown) corresponding to the locations of the hooks 40 that each include flat sections facing in opposite directions to the curved portions of the hooks 40 when the backrest 24 is installed on the seat portion 22, as shown in FIG. 1.

In order to separate the backrest 24 from the base 22, the curved portions of the hooks 40 are aligned with the flat sections of the bar 42. When the child seat 10 is in its normal position and the backrest 100 is positioned as shown in FIG. 1, the hooks 40 are in contact with the curved perimeter of the bar 42. As a result, separation of the backrest 24 from the base 22 is prevented. If the backrest 24 is pivoted past a point of normal operation, for example greater than 45 degrees from the vertical position shown in FIG. 1, separation of the backrest 24 from the base 22 is still prevented due to the opposite facing of adjacent hooks 40. For example, when the backrest 24 is pivoted to a position in substantially the same plane as the base 22, separation of the backrest 24 and the base 22 would not occur because each hook 40 engages at least one quadrant of the curved perimeter of the bar 42. The bar 42 or hooks 40 may further include nubs or protrusions to alert the user when the backrest 24 is being reclined past the maximum angle of suggested operation.

The exemplary embodiment of the present invention shown in the drawings includes three hooks. However, three hooks is only the minimum number of hooks required by the present invention. The scope of the present invention includes a connection having four or more hooks, as long as at least one of the hooks is oriented in a generally opposite direction as one of the remaining hooks to prevent an undesired separation of the backrest from the backrest. Furthermore, the scope of the present invention also includes a backrest and seat base arrangement in which the hooks 125 are attached to the seat base 200 and the bar 225 is attached to the backrest 100. The attachment mechanism between the seat portion 22 and the backrest 24 is further described in U.S. patent application Ser. No. 10/691,618 published as Publication No. US 2004/0090094 A1, the disclosure of which is hereby incorporated by reference as if set forth in its entirety herein.

Referring again to FIGS. 1-3, as described above, the seat base 26 supports a seating surface 28, a pair of armrests, and one or more object holders 32. The armrests 30 are laterally spaced from each other and extend in a fore-aft direction, and are positioned laterally outboard of the seating surface 28. Advantageously, the armrests 30 each define an upper surface 31 that has a laterally outboard edge whose height that is greater than the height at its laterally inboard edge. In accordance with certain aspects of the present invention, the upper surface 31 defines an angle with respect to the horizontal, the angle being within a range whose lower end has a range that includes and is between 0°, 5°, and 10°, and whose upper end has a range that includes and is between 25°, 40°, and 60°. The sloped upper surface 31 allows the actual distance between the inboard and outboard edges to be greater than the lateral distance between the inboard and outboard edges if, for instance, the upper surface 31 extended in a pure horizontal direction, thus allowing the present armrest to have a greater usable surface area for the occupant. The occupant can thus engage the armrest 30 with greater comfort than conventionally achieved. It should be appreciated that unless otherwise specified, the terms “inboard” and “outboard” are used to define a special relationship relative to the lateral and/or fore-aft midpoint of the booster 20 or other specified structure such that the term “inboard” is used to identify a location closer to the midpoint and the term “outboard” is used to identify a location further from the midpoint.

The armrests 30 may be of fixed or variable height. As shown in FIG. 2, the seat base 26 includes two upwardly extending sections 46 that receive the armrests 30. Each armrest 30 can include a flexible tab 50 that can be integrally formed with the armrest 30 during an injection molding process or discretely attached to the armrest 30. The tab 50 can include one or more protrusions 52 that are positioned to engage one of at least two vertically spaced apertures 54 extending through the laterally outer wall of the armrest receiving sections 46. The apertures 54 are shaped to receive the protrusions 52 in an interlocking manner. As described above, each armrest 30 has a lower surface that defines a groove 48 that properly locates the lapbelt across the lower pelvic region of the seated occupant.

For convenience, FIG. 2 shows one of the two armrests 30 in an exploded view. However, according to the present invention, both of the armrests 30 can be adjustable. When one of the armrests 30 is secured in a selected position, the protrusions 52 are located in one of the apertures 54. When a change in the height of the armrest 30 is desired, the protrusions 52 are biased inwardly, and the tab 50 pivots inward relative to the armrest 30, thereby allowing the protrusions 52 to disengage from the aperture 54. The armrest 30 then may slide upward or downward, as appropriate, until the protrusions 52 engage the desired aperture 54.

While FIG. 2 illustrates protrusions located on a pivoting and flexible tab, the present invention includes suitable alternative embodiments, such as a push button or latch mechanism. Furthermore, although the drawings show the armrest 30 to be inserted into the seat base 26, the present invention contemplates several alternative arrangements, for instance one in which the armrest 30 slides over the upwardly extending portion 46 of the base 26. In such an arrangement, the flexible tab 50 and protrusions 52 would be positioned on the upwardly extending portion 46 of the base 26, and the apertures 54 would be located on the arm rest 30.

As describe above, the booster seat 20 can also include an object holder 32 that can be attached to the seat base 26 and mounted under the seating surface 28 for movement between a retracted, storage position and an extended, in-use position. FIGS. 1-3 show the container bolder 300 in the extended position. The object holder can be constructed in the manner described in U.S. patent application Ser. No. 10/691,618 published as Publication No. US 2004/0090094 A1, the disclosure of which is hereby incorporated by reference.

While various adjustment mechanisms have been described in combination with the backrest 24, the armrests 30, and the object holder 32, it should be appreciated that the present invention is not limited to the particular mechanisms described or the positions illustrated. The scope of the present invention thus intended to include suitable alternative adjustment mechanisms appreciated by one having ordinary skill in the art, and to include additional adjustment positions of the various seat components (e.g. object holder 32, seat base 26, backrest 24, armrest 32, and the like) including positions intermediate to and beyond the exemplary embodiment shown in the drawings. These seat features foster a feeling by the seated child occupant that he or she is not seated in a baby seat, but rather a customized seat having adult-like features, thereby reducing the likelihood that the child will resist seating in the booster seat 20.

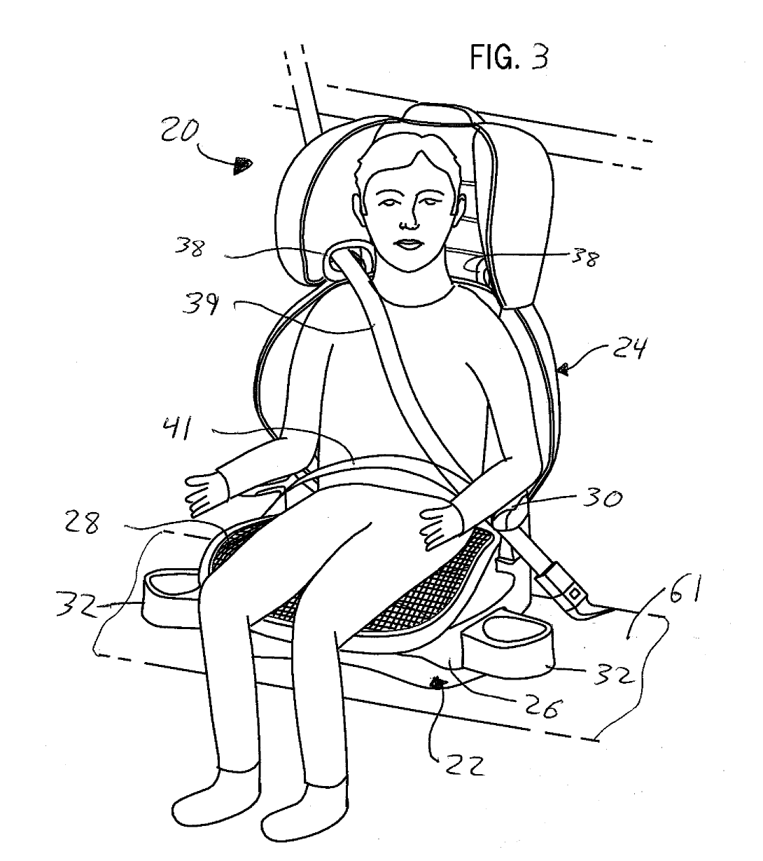

The seat base 26 will now be described with reference to FIGS. 4-8. Unless otherwise specified, the seat base 26 includes a plurality of components that can be fabricated from injection molded plastic or any suitable alternative material and process. The seat base 26 includes a lower seat support structure 60 that can be annularly configured to define the lower perimeter of the seat base 26, and an upper frame member 80 supported by the lower support structure 60. The lower support structure 60 is configured to rest on an external support surface, such as an automobile seat 61 (see FIG. 3).

The lower support structure 60 can be configured as one unitary housing member 62 (see FIG. 8) or two or more housing members connected in any known suitable manner. As illustrated, the housing member 62 is configured as inverted u-shape member that includes a front section 64, a rear section 66, and a pair of opposing side sections 68 that are either integrally or discretely connected to define the annular lower support structure 60. A substantially rectangular opening 70 thus extends vertically through the annular housing member 62, and is defined by the front, rear, and side sections 64-68.

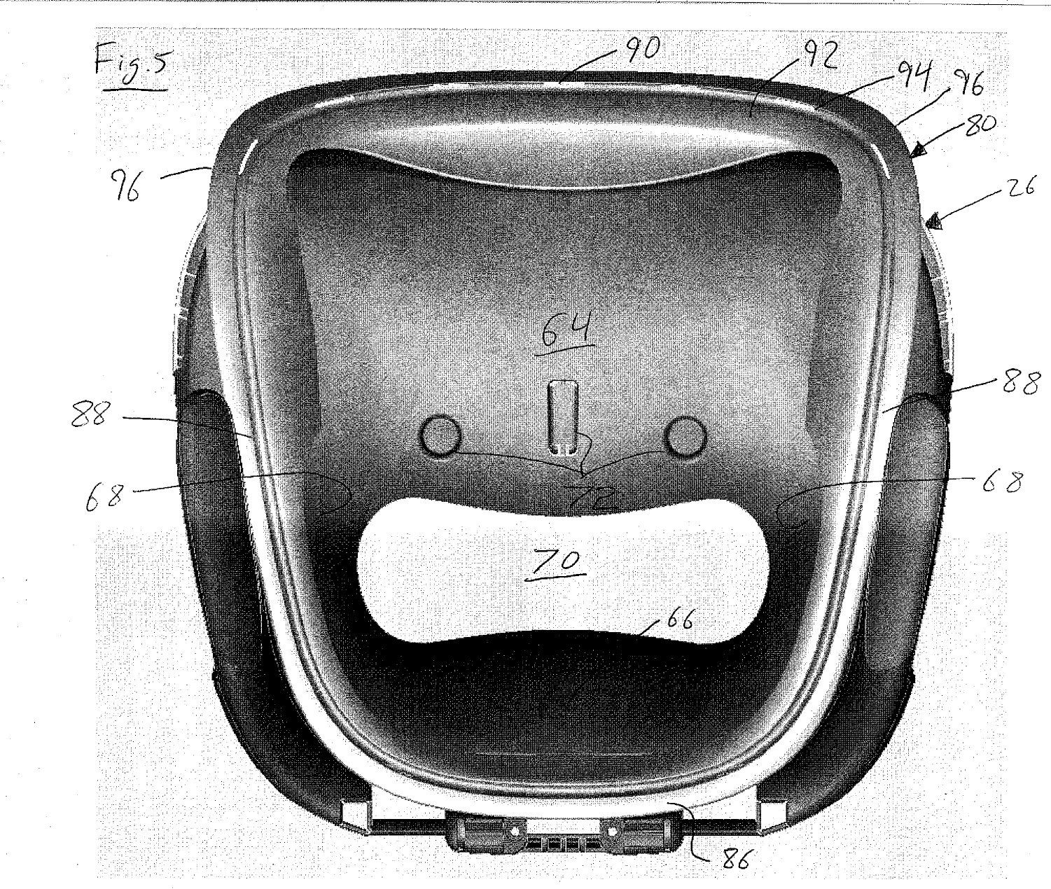

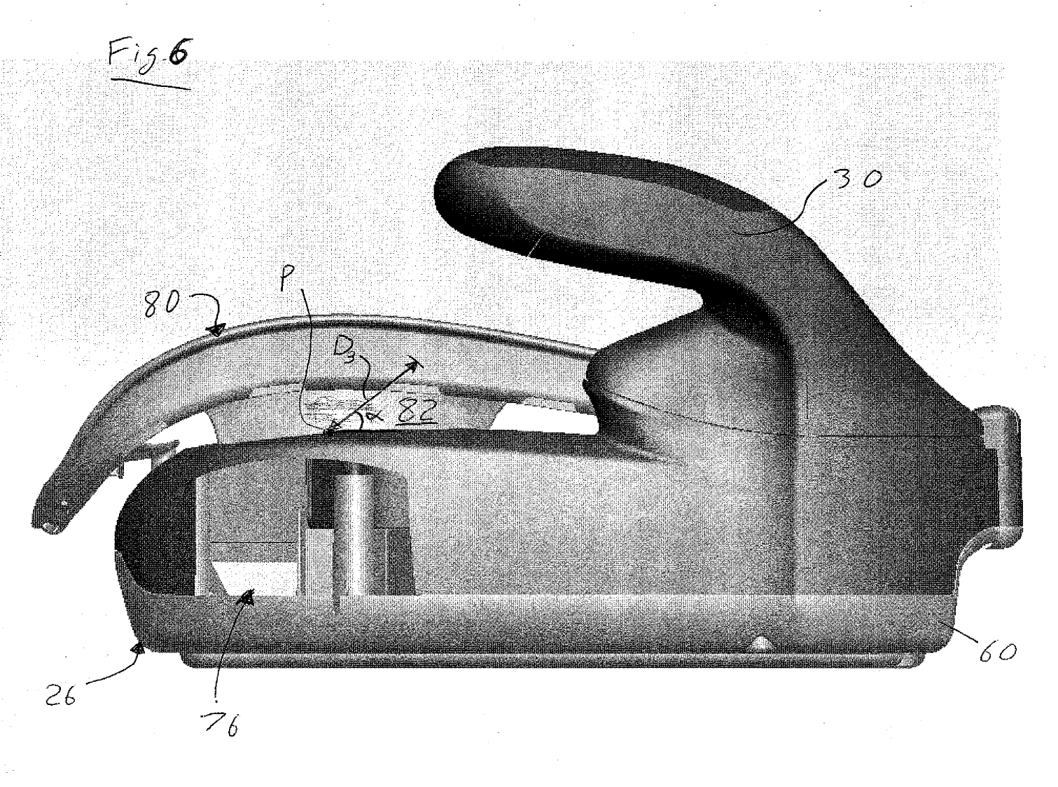

As best shown in FIGS. 4 and 6, a first vent 76 extends substantially horizontally through the front regions of the side sections 68 of the housing member 62, and through the laterally outer ends of the front section 64 of the housing member 62. As best shown in FIG. 7, a pair of second vents 78 extends substantially horizontally through the laterally outer ends of the rear section 66 of the housing member 62. Accordingly, air is free to circulate through the seat base 22 beneath the seating surface 28, as will be described in more detail below.

The housing member 62 defines an upper surface 64 that presents a concave surface with respect to the seating surface 28. The housing member 62 has a thickness between its outer edge and its inner edge that increases from the rear of the lower support structure 60 to the front of the lower support structure 60. Accordingly, the upper surface 64 is longer in the fore-aft direction at the front of the lower support structure 60 than at the rear of the lower support structure 60.

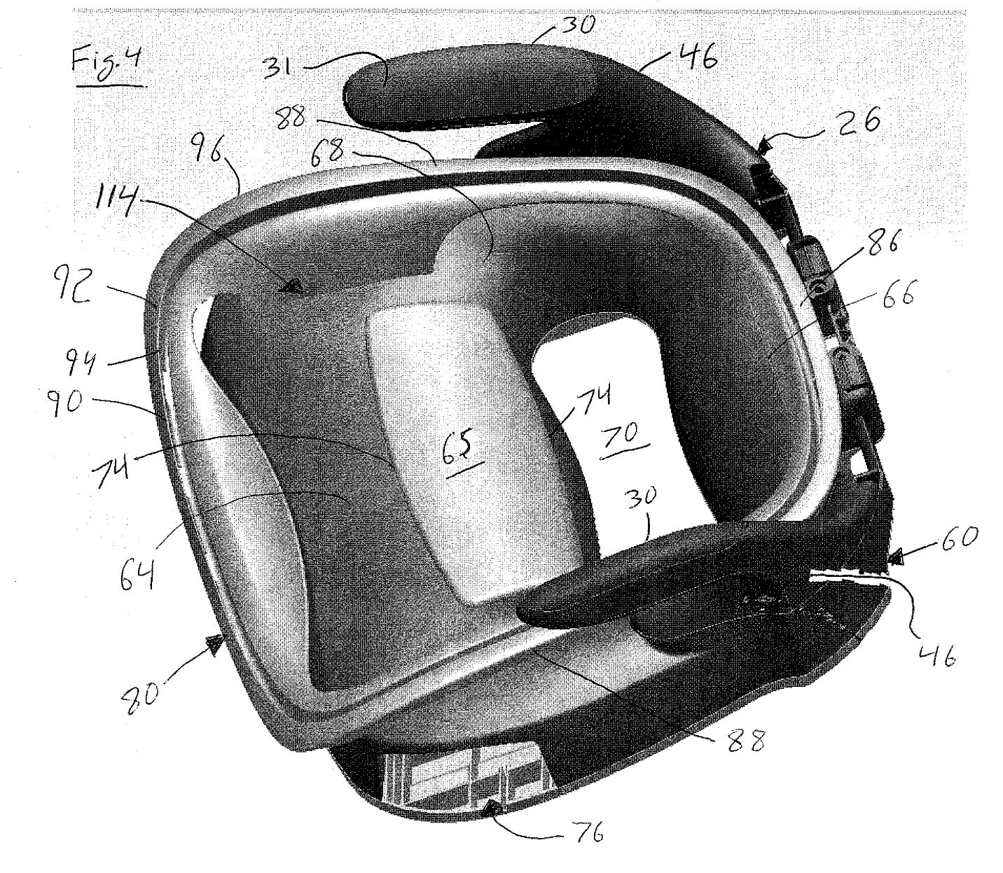

Referring now to FIG. 4, a crash pad 65 is attached to the housing member 62 at the upper surface 64 at one or more attachment locations 72 (see FIG. 5). As illustrated, the crash pad 65 is located on the front section 64 of the housing member 62 at a location beneath the seating surface 28, and is sloped upwardly in a direction from aft-to-fore. The crash pad 65 can approximate the shape of a laterally elongated rectangle having upper and lower edges 74 that are curved outwardly to define a concave surface. The crash pad 65 can have a substantially constant thickness such that the pad 65 extends substantially flat along the front section 64 of the housing member 22. Alternatively, as illustrated in FIG. 7, the thickness of the crash pad 65 can increase in a direction from its front edge toward its rear edge. Alternatively still, the crash pad 65 can have a thickness that increases from the front and rear ends of the pad towards the middle region of the pad 65, and/or that increases from the side ends of the pad towards the middle region of the pad 65.

As illustrated in FIG. 8, the seating surface 28 defines a front end 29, a rear end 31 disposed opposite the front end, and a middle portion 33 disposed substantially midway between the front end 29 and the rear end 31. Referring to FIG. 15, the crash pad 35 defines a target zone 37 configured to contact the seating surface 28 in response to abrupt deceleration of the occupant, for instance during an automobile accident. In accordance with one aspect of the present invention, the target zone 37 can be positioned forward of the middle portion 33 of the seating surface 28.

The crash pad 65 can be formed from a semi-compliant material, meaning that the pad can dent or yield when subjected to an external force. For instance, the crash pad 65 has an outer surface that can deflect either plastically or elastically in response to an applied force that is greater than a predetermined value. Examples of suitable materials include EPS (expanded polystyrene), EPP (expanded polypropylene), and other suitable alternatives. The pad thus has a hardness value that is less than that of at least one, and in certain aspects all, of the remaining components of the housing member 62 to which the pad 65 is attached. As will be described in more detail below, the crash pad 65 is positioned to contact the buttock region of the seated occupant in the event of an automobile accident and soften the abrupt deceleration of the occupant while preventing the automobile harness from riding up along the occupant to a location where it presses against the soft tissue of the occupant.

Referring again to FIGS. 4-8, the seat base 26 further includes an upper frame member 80 supported by the lower support structure 60. Specifically, a pair of stanchions 82 extends upwardly from the side sections 68, and can be either discretely attached to, or integrally formed with, the lower support structure 60. The upper end of each stanchion 82 is attached (either discretely or integrally) to the upper frame member 80. As illustrated in FIG. 7, the rear end of the upper frame member 80 is further attached to the lower support structure 60 via a pair of screws 83 extending through vertically extending screw bosses 84 that connect the upper frame member 80 to the lower support structure 60. A third screw extends through a screw boss (not shown) extending centrally through the front end of the upper frame member 80 and attaching to the lower support structure 60.

As best shown in FIGS. 4-5, the upper frame member 80 is configured as an annular rim having an undulated contour having a rear end 86 that is lower than opposing side regions 88, and a front end 90 that is lower than the rear end 86. To provide a rim which conforms to the body of a user, the side regions 88 and the rear end 86 curve upwardly. To minimize pressure on the underside of a user's thighs near the knees, the front end 90 of the frame member 80 curves downwardly. The frame member 80 has a maximum height proximate to the front end 90 to define a contour for the seating surface 28 that achieves enhanced comfort and safety to the seated occupant with respect to conventional booster seats.

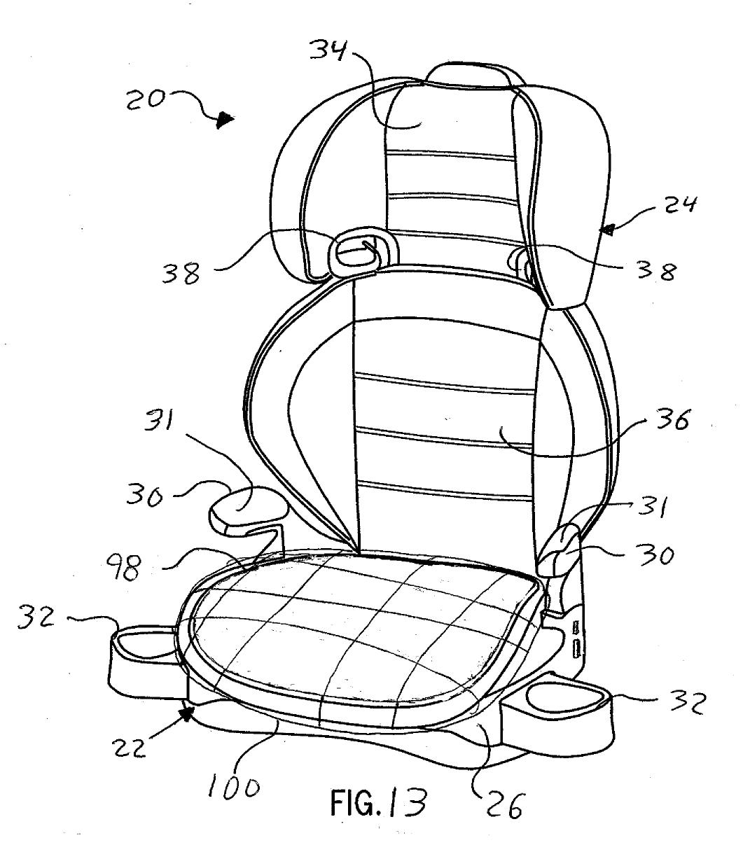

The upper frame member 80 defines an upper lip 92 and a channel 94 extending vertically into the lip. The channel 94 can also be in the shape of a “J” such that the channel has a vertical upper component and a laterally inwardly extending lower component. The channel 94 does not extend entirely through the upper frame member 80 in accordance with the illustrated embodiment, but rather is open only at its upper end. The channel 94 provides a securement mechanism for a carrier member 112 that attaches to the seating surface 28. The lip 92 includes a flange 96 that extends laterally outward from the channel and provides a catch that can facilitate attachment to an auxiliary member, such as a seat cover 98 as illustrated in FIG. 13. Specifically, the seat cover 98 can have an elastic outer edge 100 (or alternatively a drawstring or any suitable alternative mechanism) that slips over and contracts around the flange 96 to secure the seat cover 98 over the seating surface 28.

As best illustrated in FIG. 8, the front end 90 of the upper frame member 80 further includes a rearwardly extending flange 102 that presents a convex surface with respect to the seating surface 28. The flange 102 provides a seat for a foam or similarly soft pad 104 disposed between the frame member 80 and the seating surface 82. The pad 104 can be formed from a polyurethane foam or similar material, and extends laterally along the entire width of upper frame member 80. The pad can be positioned such that it contacts the seating surface 28 when an occupant is not seated or, alternatively, the pad 104 can be spaced downwardly from the seating surface 28 such that the seating surface 28 contacts the pad 104 when the seating surface 28 deflects downwardly in response to an applied force from the seated occupant. The pad 104 can present a convex upper surface or a substantially flat upper surface to provide a desired level of cushioned support to, for instance, the thighs of the seated occupant.

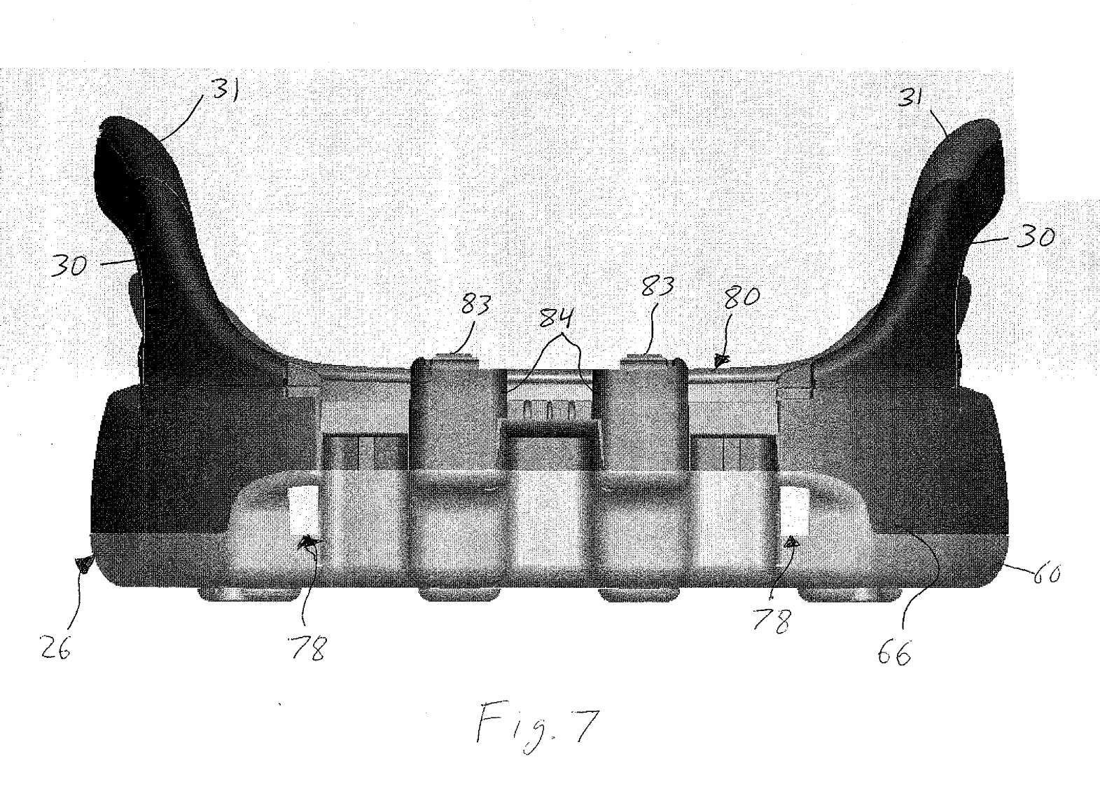

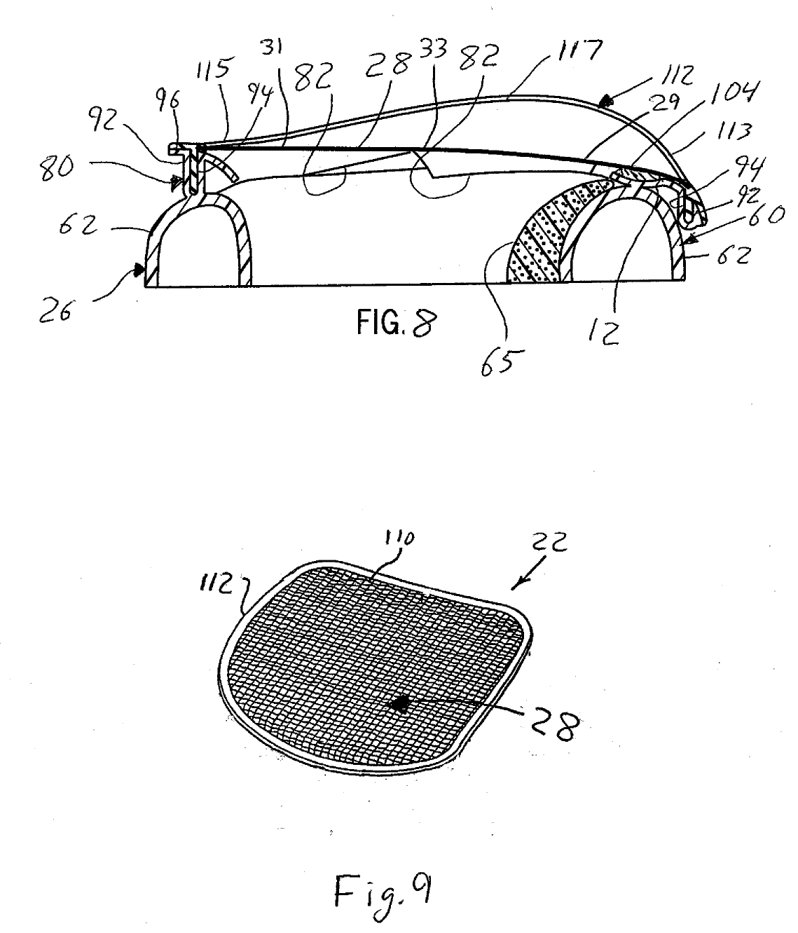

Referring also to FIG. 9, the seating surface 28 incorporates a uniquely engineered suspension fabric. The suspension fabric design alleviates pressure points against a child's bottom by supporting the weight of the child and suspending the child's bottom above any hard surface. The suspension seat design also enhances the overall comfort of the child as the child rides in the car by dampening minor bumps and vibrations. In addition, the overall visual design of the disclosed booster seats 20 offers a uniquely differentiated look from other such seats on the market that are normally seen as dull, boring and unappealing to booster-age children.

The seating surface 28 can be formed from a suspended self-adjusting elastic membrane 110 that is attached, in one aspect substantially about its entire periphery, to the carrier member 112. The term “suspended” is intended to encompass a seating surface wherein the seating surface is only attached to the carrier or surrounding frame structure at its periphery. The present invention recognizes that it may be desirable to tack the suspended membrane 110 to an underlying seat base component, and accordingly the term “suspended” further includes a substantial majority of the seating surface (i.e., at least 95% or at least 98% of the seating surface) that is surrounded by the perimeter of the seating surface suspended above the seat base 26 (i.e., not “tacked” down). To the extent that the seating surface 28 is tacked down at locations disposed inwardly with respect to the perimeter of the seating surface, the seating surface will define regions adjacent the tacked-down locations that are under tension and flexible so as to deflect in the manner described below.

The carrier member 112 is removably received by the continuous channel 94 extending into the upper frame member 80. Although the carrier member 112 is securely held by the seat frame 26 within the channel 94, a strip (not shown) can provided on the underside of the carrier member 112 and an interlocking strip (not shown) can be provided on a bottom surface of the channel 94 to further secure the carrier member 112 to the frame 26. The interlocking strips can be hook and loop type fasteners such as VELCRO® and can be configured as separate tabs spaced around the periphery of the carrier member 112 and channel 94.

The carrier member 112 can be made from a pliable yet semi-rigid thermoplastic polyester material such as polybutylene terephthalate (PTB), polystyrene or glass-filled polypropylene. The membrane 110 can be in-molded with the carrier member 112 as described in more detail below. Thus, the carrier member 112 is deformable yet has sufficient rigidity to maintain the desired contour of the membrane 110 when inserted in the channel 94. To this end, as illustrated in FIG. 8, the carrier member 112 is formed with the same contour as the channel 94 including a downwardly extending front portion 113 similar to the curvature of the front end 90 of the upper frame member 80, and an upwardly extending rear portion 115 and side region 117 similar to the curvature of the rear end 86 and side regions of the upper frame member 80.

In addition, the carrier member 112 is configured to follow the contour of the top surface of the upper frame member 80 around its perimeter. A smooth transition from the carrier member 112 to the frame member 80 is therefore provided, which is especially desirable in the front portion of the seat where the legs of a user rest. To provide a smooth transition from the membrane 110 to the front portion of the carrier member 362, the periphery of the membrane 110 is attached to an upper inner corner of the carrier member 112 at generally the same angle as the top surface of the carrier member 112. The remaining portion of the membrane 10 is shown attached to the carrier member 112 at a different angle than the corresponding top surface of the carrier member 112. However, it will be understood that the method for attaching the membrane 110 to the carrier member 112 allows any desired “entry-angle” between the periphery of the membrane 110 and the carrier member 112.

Another feature of the chair 30 which assists in comfortably supporting a user in ergonomically desirable positions is the configuration of the seat portion 22. With further reference to FIGS. 4 and 9, the upper frame 80 supports the elastic membrane 110 across a central opening 114. The membrane 110 can include a plurality of interwoven fibers as discussed in more detail below. The membrane 110 has an undulated profile similar to that of the upper frame member 80 and carrier member 112.

As shown in FIGS. 10-12, the membrane 110 can be made of a plurality of elastomeric monofilaments 118 interlaced with a plurality of strands 120 of fibrous yarn typically used in textile upholstery weaving. The elastomeric monofilaments 118 are extruded from a block copolymer of polyetramethylene terephthalate polyester and polytetramethylene ether. Preferably, this material is Hytrel™ which is produced by the E.I. DuPont DeNemours Company and has a durometer of 55 on the D-scale, or more specifically, Hytrel® grade 5544 or 5556. The monofilaments 118 are extruded by standard industry techniques which are well known to those skilled in the art. During the extrusion process, the monofilaments 118 are annealed while under tension to orient the polyester molecules in one direction while leaving the poly ether molecules unaffected. This increases both the tensile strength and the modulus of elasticity of the monofilaments 118.

The elastomeric monofilaments 118 are the primary load-carrying members of the membrane 110 and preferably run laterally in the warp direction between the side portions of the seating surface 28 to comfortably support a user. The monofilaments 118 conform to the shape of a user's buttocks and also conform to the natural movement of the body. In one aspect of the present invention, the monofilaments 118 are prestretched between 6% and 9% elongation to maintain the desired contour of the membrane 110 prior to imparting a load on the membrane 110. In addition, the prestretching produces the optimum conforming characteristics of the monofilaments 118. A plurality of elastomeric monofilaments can also run longitudinally in the weft direction between the rear and the front of the seating surface 28 to provide further support which may add to the comfort of the seat portion 22. If elastomeric monofilaments are provided in both the lateral and longitudinal directions of the seating surface 28, the monofilaments in the lateral direction can be pretensioned a desired amount and the monofilaments in the longitudinal direction can be pretensioned a different amount to produce the desired pressure distribution of the seating surface 28.

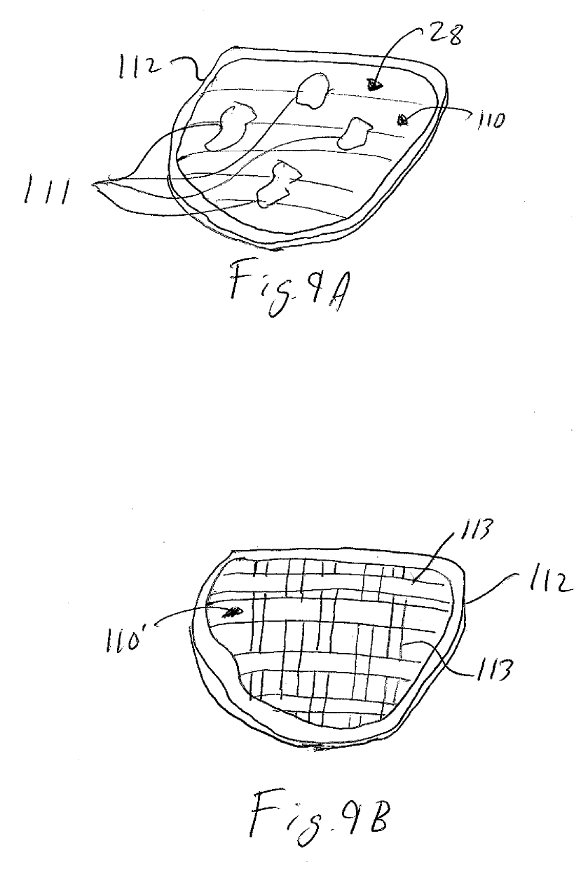

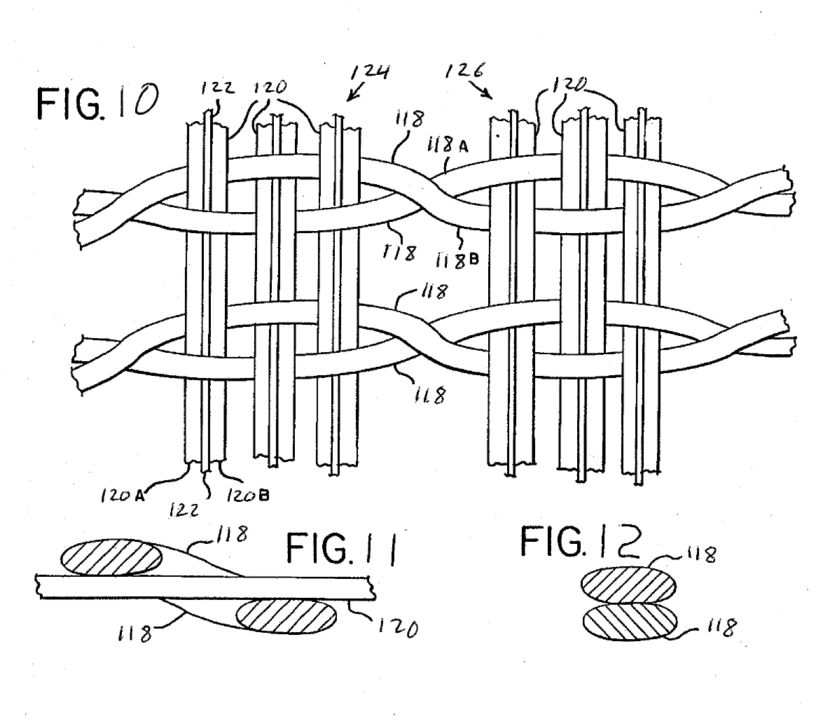

To provide greater comfort to a user, the cross-sections of the elastic monofilaments 118 can have a width to height ratio in the range of 1.5/1 to 2/1. This provides greater comfort because the increased width of the monofilaments provides a greater surface area for supporting a user which distributes the forces acting on the user. Thus, the user feels less pressure from the individual monofilaments 118 as opposed to round monofilaments which are more like concentrated pressure points. In addition, the greater width of the monofilaments 118 creates a more opaque appearance of the membrane 110 which is attractive and may lessen the perception that the user is sitting on a net rather than a conventional cushion. In addition, the cross-section of the monofilaments 118 is preferably elliptical as shown in FIGS. 11 and 12 to provide a less abrasive support. The monofilaments can be configured with various other cross-sectional shapes which are less abrasive than a conventional round monofilament.

Referring again to FIGS. 10-12, the fiber strands 120 run longitudinally in the weft direction of the seating surface 28 and are preferably arranged in groups of three. Each strand 120 preferably includes adjacent multifilament bundles 120A and 120B of spun, textured, or twisted 1500 denier Nylon or polyester yarn. To provide additional support in the longitudinal direction of the seating surface 28, an elastic monofilament 122 such as spandex is incorporated into each strand 120 by spinning, air jet texturing or covering the monofilament 122. The monofilaments 122 are preferably Lycra™ monofilaments sold by the E.I. DuPont DeNemours Company, although other materials such as Hytrel® can be used to provide the desired support. The monofilaments 122 can be secured to the strands 120 in any suitable manner such as wrapping the fibers of bundles 120A or 120B around the monofilaments 122. In addition, a desired number of monofilaments 122 can be provided. The strands 120 are preferably prestretched between 3% and 5% elongation in order to maintain the desired contour of the membrane 110 with no load imparted on the membrane 110. In addition, the strands 120 are secondary load bearing members of the seating surface 28 and the prestretching produces the optimum conforming characteristics of the strands 120 when a child sits on the membrane 110.

As shown in FIG. 10, the strands 120 can be interlaced with the elastomeric monofilaments 118 in an attractive, tightly woven pattern having spaces or openings between rows and columns of the monofilaments 118 and strands 120 that allow air to flow through the fabric for ventilation, which reduces discomfort for the occupant in warm weather. The strands 120 are held in groups of three by pairs of the elastomeric monofilaments 118 which cross over between each group of strands. For example, monofilaments 118A and 118B are shown in FIG. 10 crossing over between a group 124 and a group 126 of strands 120. To maintain the spacing between each strand 120 in a group, the monofilaments 118 weave alternately above and below adjacent strands in the group. The plurality of strands 120 provide a relatively large surface area of nonabrasive fabric which distributes the forces acting on a user to avoid a “grid-mark” type feel resulting from the concentration of pressure. In addition, the weave pattern provides sufficient aeration through the openings between the monofilaments 118 and the strands 120 to allow evaporation of perspiration and facilitate air circulation to minimize heat buildup.

The fabrication of the membrane 110, the carrier 112, and attachment of the membrane 110 to the carrier can be carried out by one of several methods easily appreciated by one having ordinary skill in the art. One such method is described in U.S. Pat. No. 6,386,634, assigned to Herman Miller, Inc.

While the seating surface 28 can comprise the suspended woven fibrous membrane 110 as described above, the present invention contemplates that the seating surface 28 can instead comprise a membrane that is nonwoven and/or non-fibrous. For instance, as illustrated in FIG. 9A, a seating surface membrane 110′ can be formed from a compliant nonwoven thermoplastic material. In this embodiment, one or more apertures 111 can extend vertically through the membrane 110 to provide a porous membrane that facilitates aeration for the seated occupant. Alternatively, as illustrated in FIG. 9B, the membrane 110′ can be formed from a nonwoven thermoplastic material that provides a plurality of woven strips 113 that provide the seating surface 28. The woven membrane 110 can define interstices that provide porosity to facilitate aeration.

As described above with reference to FIGS. 4-7, a first vent 76 and a second vent 78 extends through the housing member 62 at a location below the seating surface. The vents 76 and 78 advantageously cooperate with the porosity of the seating surface 28 to allow for air circulation beneath the seating surface that provides convective cooling to the bottom of the seated occupant. Furthermore, the opening 70 extending vertically through the annular housing member 62 and is in at least partial vertical alignment, including full alignment, with the seating surface 28 so as to provide for easy clean-up of particles that may fall through the seating surface 28. Instead of being trapped inside the housing member 62, similar to conventional child seats, the particles flow through the booster seat 20 and onto the supporting surface, which can be covered with a mat or other like protective barrier.

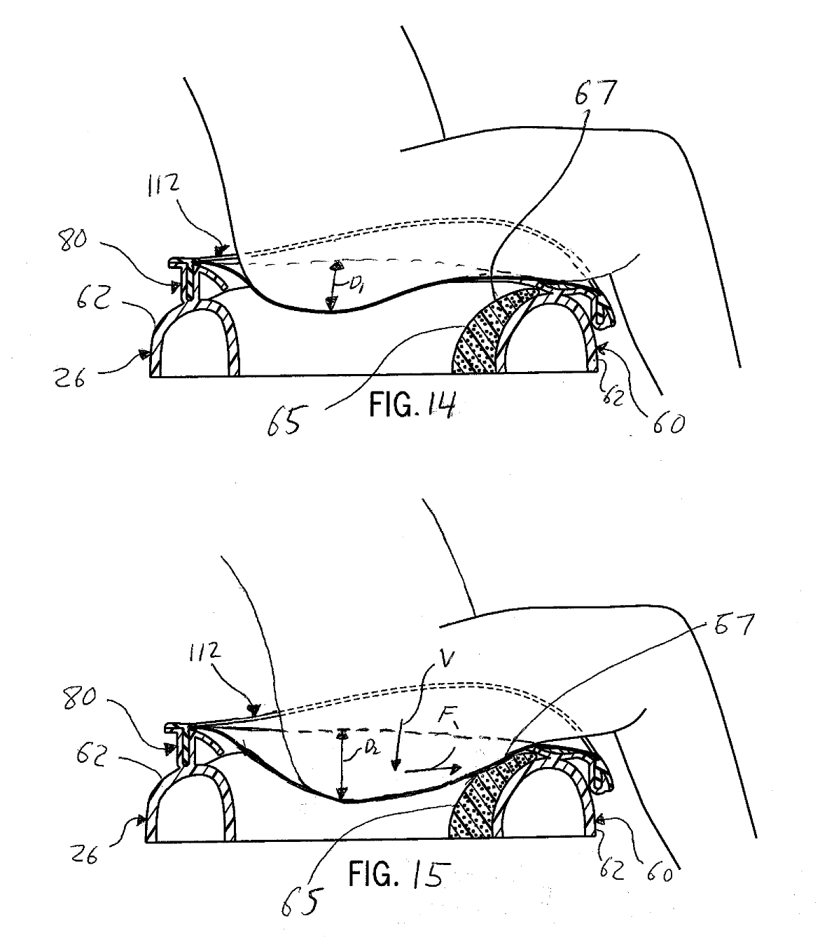

Referring now to FIGS. 14-15, the crash pad 65 is configured to provide a downward travel limiting surface for the seating surface 28, and thus seated occupant. Specifically, the crash pad 65 is sized, shaped, and positioned in proximity with respect to the seating surface 28 such that the seating surface 28 contacts the pad 65 in response to a predetermined condition (i.e., a sudden deceleration of the type experienced in an automobile accident). As described above, the seating surface 28 can be formed from a suspended elastic membrane 110 and thus deflects a vertical distance D1 in response to the weight of a seated occupant. The distance D1 is the distance between the lowest point of the seating surface 28 when the occupant is seated in the booster seat 20 and when the booster seat 20 is vacant. When the seat portion 22 is occupied, the occupant's buttocks and legs are suspended above the pad 65.

However, when a moving vehicle suddenly stops or slows abruptly, the child sitting on the suspension seating surface 28 will travel forward in the direction of Arrow F and vertically down in the direction of Arrow V into the seat portion 22 as a result of the child's inertia. Without the pad 65, the child may travel down as much as four inches. This could cause the lap belt to ride up or move from its proper position, i.e., the bony hips of the child, to an improper position, i.e., the soft abdominal tissues of the child. The improper position of the belt could then lead to seat belt syndrome injuries.

Instead, as illustrated in FIG. 15, when the child travels down and forward in response to sudden vehicle deceleration, the force exerted on the child is transferred to the seating surface 28 which, in turn, deflects a vertical distance D2 greater than D1 and causes the buttocks/upper leg region of the occupant to contact a target zone 67 of the crash pad 65 (via the seating surface 28).

In accordance with one aspect of the present invention, the pad 65 is located less than a predetermined vertical distance from the seating surface 28 such that the child travels down a distance less than the distance that would cause the safety harness to press against soft tissue. In accordance with certain aspects of the invention, at least one region on the pad 65 is disposed a distance from the seating surface 28 within the range that includes 0.75 inch, 1 inch, 1.5 inches, 2 inches, 3 inches, and 3.5 inches, and distances therebetween. In other aspects of the invention, the distance is between 0.75 and 4 inches. A distance less than 4 inches minimizes the likelihood of seat belt syndrome, as is described in more detail below. As illustrated in FIG. 6, the distance D3 is measured from a given location P on the pad 35 along the aft direction to the seating surface 28 at an angle α of 45° with respect to the horizontal.

In accordance with another aspect of the present invention, in addition to preventing the child from traveling down to a point where he/she may sustain soft tissue injuries caused by seat belt syndrome, the pad 65 further allows the child to decelerate more gently with fewer impact injuries than might otherwise be sustained. As described above, the pad 65 is formed from a semi-compliant material, meaning that the outer surface of the pad 65 will deflect either plastically or elastically in response to the impact. The pad 65 thus presents a target zone 67 that is configured to contact the seating surface directly below the body of the occupant. Accordingly, as the occupant travels down and forwards along the direction of Arrows V and F, the pad 65 will deflect and absorb at least a portion of the shock.

The ramp geometry can also be optimized for children within a given or desired weight range, such as for example, a range of about 30 lbs to about 100 lbs. Children weighing at both ends of the weight range can be adequately suspended by the seating surface membrane 110 and while not fully resting on the crash pad 65. When a child's bottom sitting in the suspended fabric seat rests on the pad surface, this would be referred to as “bottoming-out.” During normal operation, the buttocks and upper leg region of the seated occupant is suspended above the crash pad 65. In response to a sudden deceleration of the vehicle, the seated occupant exerts a force onto the seating surface 28 causing the seating surface 28 to further deflect downward and forward until the suspended fabric disposed directly beneath the child's bottom contacts the pad, and the impact absorption provided by the pad 65 is transferred through the seating surface 28 to the seated occupant.

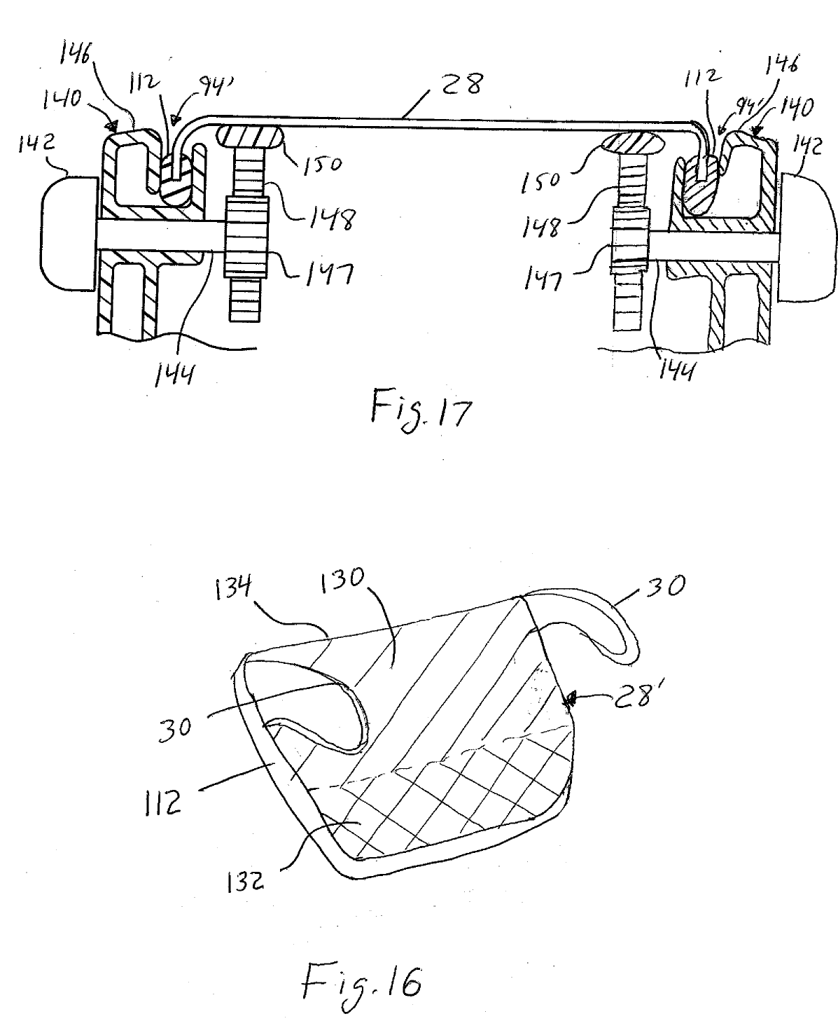

In the above-described embodiments, the entire seating surface is configured with a tension that deflects a predetermined distance in response to an applied force (i.e., a seated occupant). In accordance with certain aspects of the present invention, the seating surface 28 can be configured with different zones of tension. For instance, referring to FIG. 16, a seating surface 28′ can be provided with at least two adjacent zones: a first zone 130 designed for higher occupant comfort and a second zone 132 designed for higher seat performance. The phrase “comfort zone” is thus used herein to define the region of the fabric seating surface from the bight 134 of the seat portion 22 (intersection of seating surface 28 and the back rest 24) to a set distance between the front end and back end of the frame of the seat bottom. The phrase “performance zone” is used herein to define the region of the fabric seating surface from the point where comfort zone ends to the front end of the frame of the seat bottom.

In this example, the two zones can be designed to have different fabric tension or stiffness of fabric. The zone differences can be controlled during the manufacturing process of the membrane 110, such as by controlling or altering the elastomeric textile and thermoplastic resin characteristics and/or the weave pattern, density, and the like. Alternatively, the comfort zone 130 can comprise a material different than that of the performance zone 132. The membrane 110 within the comfort zone 130 can have an average stiffness that is relatively lower than that of the performance zone 132. Accordingly, when the child occupant is seated in the booster seat 20 under normal conditions, the majority of his weight would be supported by the comfort zone 130 of the seating surface 28. In the dynamic event of a crash or a sudden stop or slowdown, the reaction of a child would first be to move forward as a result of the child's inertia until the child is stopped by the vehicle's 3-point belt system. After some stretch or deflection, the child would then articulate down with the belt connections as pivot centers. The comfort zone 130 and performance zone 132 can be located such that, as the child moves forward and begins to articulate down, the child interfaces with the performance zone 132 of the seating surface. During the sudden deceleration of the occupant, the performance zone 132 is configured to deflect a distance sufficient to come into contact with the pad 65 in the manner described above.

Advantageously, the higher stiffness of the performance zone 132 limits the downward movement of the child and thus prevents injuries related to seat belt syndrome. During normal product use, the lower tension of the comfort zone 130 provides vibration dampening, ventilation, and suspended fabric seating (elimination of pressure points) to enhance the child's comfort. While two zones have been described and illustrated with reference to FIG. 16, one having ordinary skill in the art will appreciate that any number of zones in addition to the zones 130 and 132 could be provided, the additional zones having a greater or lesser average tension than zones 130 and 132.

Referring now to FIG. 17, certain other aspects of the present invention provide for a tension adjustment mechanism 140 that allows the user to manually control the level of stiffness in the suspended membrane 110 of the seating surface 28. The mechanism 140 includes an adjustment knob 142 or other type of actuator that extends out from the seat base 26 below the seating surface 28, and can extend laterally outboard of the seating surface 28, so that it is accessible by an occupant, user and/or caregiver. In the illustrated example, a pair of laterally opposing tension adjustment mechanisms 140 is provided. Each mechanism can, for instance, be located on each side or front corner of the seat portion 22.

Each actuator or adjusting knob 142 in this example connects to an inwardly extending driven shaft 144 that is rotatably retained in a bushing 146. The bushing 146 can be connected to the upper frame member 80 (not shown in FIG. 17) in any desired manner. The bushing 146 can define an upper channel 94′ constructed similar to channel 94 that retains the carrier 80. The carrier 80 can further be adhesively or otherwise attached to the bushing 146 to ensure that the carrier 80 does not become accidentally detached. The inner end of the driven shaft 144 is connected to a gear that provides a pinion 147 that is intermeshed with a vertically extending rack 148 that is supported for vertical movement, for instance within a guide (not shown) that is connected to the seat base 26 in any desirable manner. A lifter 150 is provided at the upper end of the rack 148 at a location inward of the carrier 112, and engages the bottom of the seating surface membrane 110. The lifter 150 can have an elliptical shape, or any other suitable shape that is configured to apply variable pressure against the seating surface 28. The position of the actuator or knob 142 can be manually rotated or otherwise manipulated in a first direction that causes the rack 148 to articulate vertically, thus causing the height of the lifter 159 to increase, which in turn increases the tension of the seating surface membrane 110. The position of the actuator or knob 142 can be manually rotated or otherwise manipulated in an opposite second direction that causes the height of the lifter 150 to decrease, thus decreasing the tension in the seating surface membrane 110. If the lifter 150 is released from engagement with the membrane 110, the seating surface tension will be at its minimum as controlled by the carrier 112 to which the membrane is connected.

It should be appreciated that markings (not shown) could be present on the actuator that provides a recommended adjustment guide to the user based on the weight of the seated occupant to provide the desired comfort level while at the same time providing the performance necessary to ensure that the seating surface 28 is configured to allow the occupant to engage the crash pad 65 in the manner described above.

Although certain car seat examples have been described herein in accordance with the teachings of the present disclosure, the scope of coverage of this patent is not limited thereto. Rather, the above description has been that of the preferred embodiment of the present invention, and it will occur to those having ordinary skill in the art that many modifications may be made without departing from the spirit and scope of the invention. In order to apprise the public of the various embodiments that may fall in the scope of the present invention, the following claims are made.

What is claimed is:

1. A child car seat comprising:
a seat portion having at least one automobile safety harness guide, the seat portion further comprising a seat base, a carrier supported by the seat base, and a suspended flexible seating surface connected at its perimeter to the carrier.

2. The child car seat as recited in claim 1, wherein the carrier surrounds an entirety of the perimeter of the seating surface.

3. The child car seat as recited in claim 1, further comprising a backrest connected to a rear end of the seat base.

4. The child car seat as recited in claim 3, wherein the backrest is removably connected to the seat base.

5. The child car seat as recited in claim 1, wherein the seating surface has an undulated profile.

6. The child car seat as recited in claim 1, wherein the seating surface comprises a woven membrane.

7. The child car seat as recited in claim 6, wherein the membrane comprises a fabric.

8. The child car seat as recited in claim 1, wherein the seating surface comprises a nonwoven membrane.

9. The child car seat as recited in claim 1, wherein the membrane defines at least one aperture extending therethrough.

10. The child car seat as recited in claim 1, wherein the seat base includes at least one vent disposed beneath the seating surface to provide convective airflow beneath the seating surface.

11. The child car seat as recited in claim 10, wherein the seating surface is porous

12. The child car seat as recited in claim 1, wherein the seat base defines an aperture extending vertically therethrough, wherein the aperture is in at least partial vertical alignment with the seating surface 28.

13. The child car seat as recited in claim 1, wherein the seating surface has at least a first and a second zone, wherein the first zone has an average tension less than that of the second zone.

14. The child car seat as recited in claim 13, wherein the first zone is disposed rearward with respect to the second zone.

15. The child car seat as recited in claim 1, wherein the seat base comprises a frame member supporting the carrier, wherein the frame member comprises an outwardly extending flange configured for attachment to an auxiliary seat cover.

16. The child car seat as recited in claim 1, further comprising a pair of laterally spaced armrests supported by the seat base, wherein each armrest presents a sloped armrest surface having a height at its laterally outboard edge greater than at its laterally inboard edge.

17. The child car seat as recited in claim 1, further comprises a tension adjustment mechanism supported by the seat base, the tension adjustment mechanism including an actuator and a lifter engaging the seating surface, wherein the lifter is operatively coupled to the actuator support such that the actuator is manipulated to apply increased or decreased pressure against the seating surface.

18. A child car seat comprising:
a seat base supporting a flexible seating surface, the seating surface defining a front end, a rear end, and a middle portion disposed substantially midway between the front end and the rear end;
a crash pad supported by the base and positioned beneath and forward of the middle portion of the seating surface, such that downward deflection of the seating surface causes the seating surface to contact the crash pad.

19. The child car seat as recited in claim 18, wherein the seating surface is configured to contact a target zone on the crash pad, and wherein the target zone is positioned 0.75 inch, 1 inch, 1.5 inches, 2 inches, 3 inches, and 3.5 from the seating surface along a line extending in an aft direction 45° with respect to a horizontal direction.

20. The child car seat as recited in claim 18, wherein the crash pad is formed from material selected from the group consisting of expanded polystyrene and expanded polypropylene.

21. The child car seat as recited in claim 18, wherein the seating surface is configured to deflect downwardly a first distance in response to a seated occupant, and a second distance greater than the first distance in response to a deceleration of the seated occupant, wherein the second distance is limited by the crash pad.

22. The child car seat as recited in claim 18, wherein the seating surface is suspended.

23. The child car seat as recited in claim 18, wherein the seating surface further comprises a plurality of tensioned regions.

24. A child car seat comprising:
a seat portion having at least one automobile safety harness guide, the seat portion further comprising a seat base, a carrier supported by the seat base, and a tensioned flexible seating surface connected at its perimeter to the carrier, wherein the seating surface is configured to deflect downwardly a first distance in response to a seated occupant, and a second distance in response to a deceleration of the seated occupant.
